(19) United States
(12) Patent Application Publication
(10) Pub. No.: US 2012/0257478 A1
(43) Pub. Date: Oct. 11, 2012

(54) MEDICAL TRACKING CAP

(76) Inventor: Richard Marcellino, Brecksville, OH (US)

(21) Appl. No.: 13/438,995

(22) Filed: Apr. 4, 2012

Related U.S. Application Data
(60) Provisional application No. 61/472,261, filed on Apr. 6, 2011.

(51) Int. Cl. G04B 47/00

(52) U.S. Cl. 368/10

(57) ABSTRACT

The invention provides a container having a cap or lid including a tracking device for recording date, time, and elapsed time information, the container having opposite closed and open ends, and a cap able to be fixedly engaged with the open end of the container, the cap including a sensor for sensing closure of the container with the cap, and which initiates a digital display showing the time and day or opening and closing the container, and which tracks and displays the elapsed time since the container was last opened.

### INCORPORATION BY REFERENCE

This application claims the priority of U.S. Provisional Application Ser. No. 61/472,261, filed Apr. 6, 2011, entitled “Medical Tracking Cap” by Richard Marcellino, the disclosure of which is incorporated herein by reference in its entirety.

The invention relates in general to a medicine bottle or vial having a cap containing a clocking device. More specifically, the invention relates to a medicine bottle or vial having a cap that houses a clocking device able to track and digitally display the time and date of the last opening and closing of the bottle or vial, and the time elapsed since the bottle or vial was last opened and closed. It will be appreciated that the tracking cap which is the primary subject hereof may find application for use with any item requiring time management with regard to the opening and closing thereof.

### BACKGROUND OF THE INVENTION

The present invention relates generally to a timing indicator using a digital display to show the time and date that a medicine bottle was last opened and closed, and the time elapsed since the last opening and closure of the bottle. The timer is positioned in the lid or cap of a medicine bottle.

It is well known and well documented that errors relating to taking a prescribed medication at the appropriate time occur regularly. Such errors cause problems in the area of either overdosing if the medication is taken too early, or underdosing if the medication is not taken within the proper time frame. While keeping track of the last time a medication was taken can prove problematic for any person taking a regularly dosed medication, it can be particularly troublesome for those, for example, who are elderly and may have problems related to memory loss or slight dementia, and are still living on their own without continual professional or other care-giver supervision. The device disclosed herein will remove any doubt as to the timing of the last dosage of a particular medication. This type of device or means to track the time a last dosage was administered will also find application in medical care facilities where multiple patients are dosed in succession and where shift changes occur regularly. While current methods rely on recording of the time medication was administered, whether manually on a physical chart or electronically on a computer or other electronic mechanism, the current device provides further confirmation of the recorded information.

There are solutions available in the public domain for portioning medications to be taken on a given day, such as pill holders or containers marked with the days of the week, and others that provide an alarm that sounds when it is time for medication to be taken. There are still other devices that include a clocking and/or timing device that resets upon the opening of a bottle. Generally these devices show the current time and not the time the bottle or vial was last entered, i.e. opened and closed. What these devices lack is an indication of the time a dosage was last taken, as well as the amount of time elapsed since that last dosage.

Problems exist with the types of devices that are currently available. For example, U.S. Pat. Nos. 7,382,692, 6,845,064, 6,667,936 provide for an add-on device that is used in conjunction with an existing medication bottle cap. This type of device, however, may not fit a particular bottle or jar top or lid properly and may become dislodged from the regular cap or lid, thus interrupting the timing or not giving proper information. U.S. Pat. No. 6,317,390 provides a cap for use on a medicine container that tracks only the amount of time elapsed. While this cap provides a solution to part of the problem, it does not provide for resolving the entire problem, i.e., it does not show the day or the time of the last dosage. Further, the device disclosed in this patent requires that one use an instrument to depress a button or other feature in order to start and stop the tracking device.

There are also timing devices wherein the original lid of a bottle is replaced by a cap. This however can cause problems if the replacement cap does not fit properly to the medicine bottle or vial. There are also devices out there where the medication is completely transferred to a new container and cap. This can have problems with contamination and creates the possibility for information provided on medication containers by a pharmacy and/or manufacturer to not be transferred properly to the new bottle or container. Other devices require that the user input times and other information which can be difficult, especially for elderly patients.

Another problem that is prevalent among individuals who regularly take medication, and even more so among those who take various medications at different times over the course of the day, is the need to calculate the time that has elapsed since the last time a particular medication was taken. In that instance where multiple medications are taken, and some are taken once a day, others twice a day and still others three times or more a day, calculating times until re-dosage may be confusing and complicated, leading to mistakes in dosing.

What is lacking is a medical tracking device that automatically indicates to the user the time the dispenser was last opened and closed, the date, and the time elapsed since the time the dispenser was last opened and closed. In light thereof, provided herein is a medication bottle, vial or container, in which the medication is provided and that automatically, without the need for setting times or starting a counter, clocks and digitally or otherwise displays, in combination, the time the medication dispenser was last opened and closed, the date, and the time elapsed since the dispenser was last opened and closed. These and other features of the device provided herein will become apparent upon reading and understanding the following disclosure.

### SUMMARY OF THE INVENTION

The invention provides a container having a cap or lid including a tracking device for recording date, time, and elapsed time information, the container having opposite closed and open ends, and a cap able to be fixedly engaged with the open end of the container, the cap including a sensor for sensing closure of the container with the cap, and which initiates a digital display showing the time and day of opening and closing the container, and which tracks and displays the elapsed time since the container was last opened and closed.

### BRIEF DESCRIPTION OF THE DRAWINGS

FIG. 1A-B are side views of a container and tracking cap in accord with at least one embodiment of the invention;

FIG. 2 is a top view of the tracking cap in accord with at least one embodiment of the invention;

FIG. 3 is side view of a container and tracking cap in accord with at least one embodiment of the invention; and

FIG. 4 is an interior view of the tracking cap in accord with at least one embodiment of the invention.

### DETAILED DESCRIPTION OF THE INVENTION

The subject invention relates to a medical tracking cap that automatically resets three pieces of information every time a medicine container, for example a bottle or a jar, to which the tracking cap is attached is opened and closed, i.e., each time a dose is taken. The invention includes a container for retaining the medication, which may be in the form of solid pills or tablets or in the form of a liquid, and a cap that securely fastens to the container. The lid, in general, is a twist-off cap, though other types of caps may also benefit from the subject invention. The cap has a timing device operatively engaged with the inner portion of the cap. The cap further has a digital display panel operatively connected to the timing device and visible through the top surface or wall of the cap. The digital display panel, displays at least the following pieces of information: the time and date, in the form of month, day and year, that the cap was last removed from and replaced onto the container, i.e. the time and date of the last dosage taken, and the current elapsed time since the bottle or container was last removed from and replaced onto the container. The timing device is activated by a switch or sensor which is lodged in the sidewall or other portion of the inner surface of the medical tracking cap and is activated upon full engagement of the lid with the bottle. The tracking device may be powered by a battery.

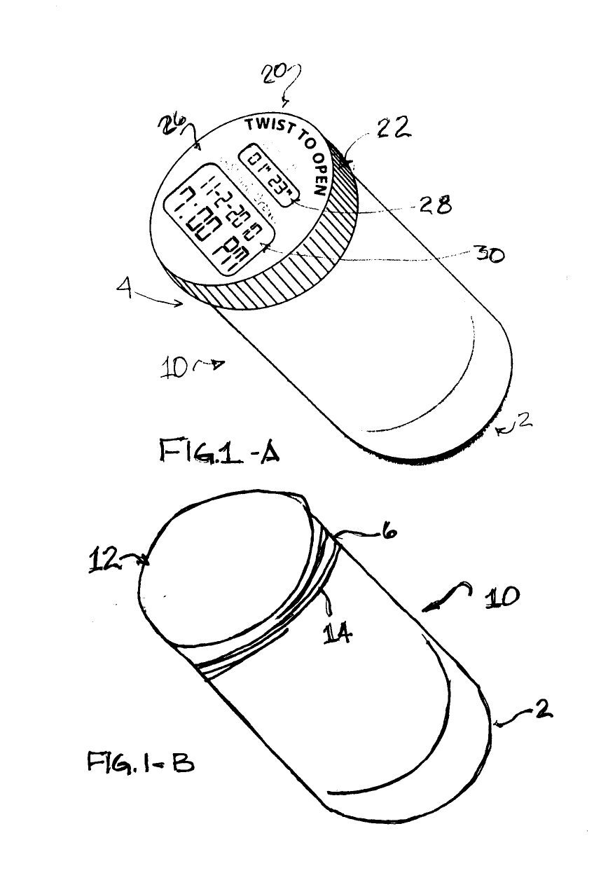

Referring to FIG. 1, there is seen a container 10. As used herein, the term “container” may be used to refer to any type of container that may be used to retain medication, such as a bottle, a vial, or other container, regardless of the shape, including for example a generally cylindrical pill bottle or a liquid bottle having a tapered neck region, or the material from which such container is made, such as for example plastic, glass, or other such material. Container 10 has a closed end 2, or bottom, and an open distal end 4, or top, for receiving tracking cap 20. The tracking cap 20 has a peripheral sidewall 22, which generally defines a circular perimeter shape and is sized to fit over distal end 4 of the container and tightly engage threading 14 on the exterior surface 6 thereof. Tracking cap 20 further includes a top wall 26 which is generally perpendicular in orientation to peripheral side wall 22. In general, the cap is circular and fits a circular opening 12 at distal end 4 of container 10. The container may be of the type of bottle shown in FIG. 1, consistent with a conventional pill or tablet bottle, or it may adopt the shape generally known for use with liquid medications, having a cylindrical or oval-shaped lower portion proximate lower end 2 which generally retains the liquid, narrowing toward the distal end 4 through neck portion 8 as shown in FIG. 3. Though tracking cap 20 is shown herein to be of the type that screws onto substantially circular opening 12 of container 10, it is understood that any type of cap may benefit from the tracking cap so long as the cap, upon closure, activates a sensor or switch disposed in the interior of the cap to operate the digital displays set forth herein. For example, the cap may be pushed onto the open end of the container, as in a snap-on type of cap (not shown).

With further reference to FIG. 1, there is shown first digital display panel 28, that displays the time elapsed since the lid was last removed from container. A second digital display panel 30, digitally displays the time and the date, as month, day and year, that the bottle was last opened and closed, i.e. the date and time that the last dose was taken. It is critical that both the day and the time be shown, given that some medications are taken every other day, or some may be taken only once a week, thus making not only the time but the date of the last dosage a critical piece of information for one taking such a medication.

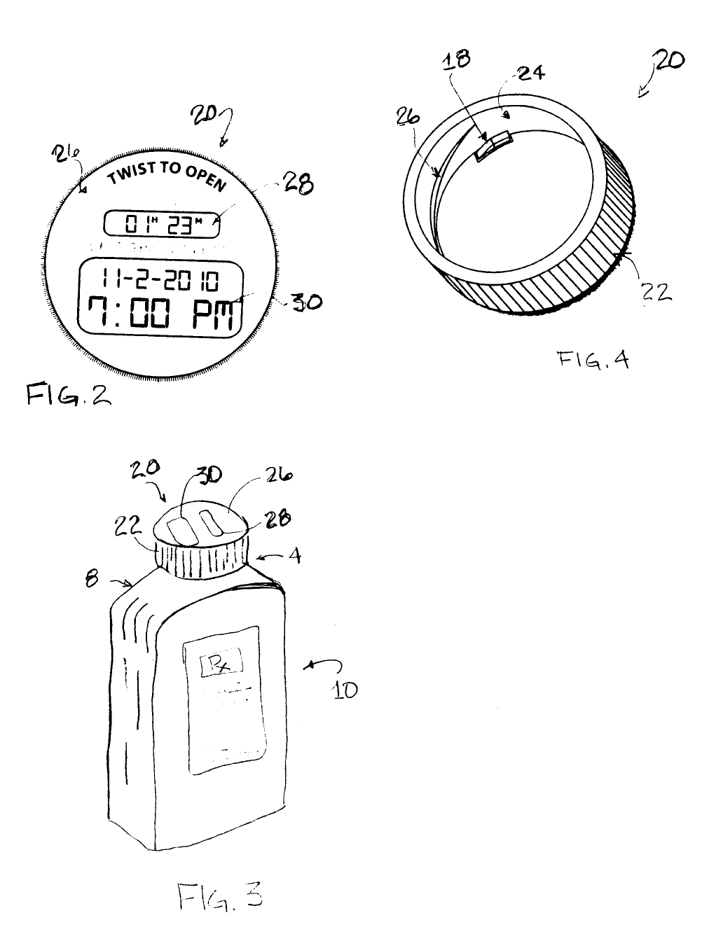

FIG. 2 provides a view of top wall 26 of the tracking cap 20, showing both the first digital display panel 28 and the second digital display panel 30. As will be appreciated by the reader, the positioning or placement of the first display panel 28 and the second display panel 30 is not critical, so long as both panels are present. Alternatively, each of the three pieces of information, i.e. time, date and elapsed time, may be displayed in a single panel, in three different panels or in any combination within two panels, for example such as that shown in FIG. 1 or 2.

FIG. 4 provides a view of the inside of the tracking cap 20 as defined by the interior surface 24 of peripheral side wall 22. As is shown, peripheral sidewall interior surface 24 has protruding threading 26 for mating with and fixedly engaging the exterior threading 14 around the exterior circumference of substantially circular opening 12 of container 10. Also shown is sensor 18, which upon engagement with the bottle causes the timing device to reset the time and date display to the current time and date, and to initiate the clock to track time until the next time the container is opened and re-closed. Sensor 18 may be a pressure sensor, a simple switching mechanism, or any other mechanism suitable for placement on an interior surface of cap 20 such that upon engaging the exterior surface 6 of container 10 distal end 4 the sensor, switch or other mechanism is activated. Also provided is a battery (not shown), such as a watch battery, or other power source for providing power to the sensor and or digital displays. The digital displays 28, 30 may be set within and flush with the surface of top wall 26, and may comprise, for example, LCD display technology or any other suitable means for generating a digital display or readout.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A container having a tracking device for recording date and time information, the container comprising:
a container for holding an item and having a closed bottom end and an open distal end,
a tracking cap able to be fixedly engaged with the container at the open distal end thereof in order to close the same,
a sensor disposed within the interior portion of the tracking cap in operative communication with a clocking device also disposed in or on the tracking cap, and
one or more digital displays, in operative communication with the clocking device, for displaying date, time, and elapsed time information.

2. The container of claim 1 wherein the container is a pill bottle or liquid vial.

3. The container of claim 1 wherein the cap includes an interior sidewall having threading for engaging with associated threading on an exterior surface of the distal end of the container.

4. The container of claim 1 wherein the sensor is selected from the group consisting of a pressure sensor and a switch.

5. The container of claim 1 wherein the at least one digital display receives power from a battery.

6. The container of claim 5 wherein the battery further provides power to the sensor.

7. A method of tracking the time elapsed between the open and closure of a container, the method comprising:
providing a container for holding an item and having a closed bottom end and an open distal end,
providing a tracking cap able to be fixedly engaged with the container at the open distal end thereof,
providing a sensor within the interior portion of the tracking cap,
providing a clocking device in operative communication with the sensor and also in or on the tracking cap, and
providing one or more digital displays on the exterior surface of the tracking cap in operative communication with the clocking device for displaying date, time, and elapsed time information,
wherein, upon engaging of the interior portion of the tracking cap with the open distal end of the container, the sensor is activated and causes the clocking device to initiate, which in turn causes the digital displays to show the date the tracking cap and container were engaged, the exact time the tracking cap and container were engaged, and the amount of time elapsed since the tracking cap and container were engaged.

8. The method of claim 7 wherein the container is a medication bottle.

9. The method of claim 7 wherein one or more of the sensor, clocking device, and digital display is powered by a battery.

10. The method of claim 7 wherein one or more of the sensor, clocking device, and digital display is powered by a solar battery.

11. The method of claim 7 wherein the tracking cap is screwed onto the container.

12. The method of claim 7 wherein the tracking cap is snapped onto the container.
